(19) United States
(12) Patent Application Publication
(10) Pub. No.: US 2026/0152662 A1
(43) Pub. Date: Jun. 4, 2026

(54) BINDER COMPOSITION WITH EXTENDED SHELF-LIFE

(71) Applicants: Owens Corning Intellectual Capital, LLC, Toledo, OH (US); Paroc Group Oy, Helsinki (FI)

(72) Inventors: Liang Chen, New Albany, OH (US); Charlotte Carita Pettersson, Turku (FI); Gert Mueller, New Albany, OH (US); Xiujuan Zhang, New Albany, OH (US)

(21) Appl. No.: 19/405,917

(22) Filed: Dec. 2, 2025

Related U.S. Application Data
(60) Provisional application No. 63/727,327, filed on Dec. 3, 2024.

(51) Int. Cl. C09D 167/02; C03C 13/06; C03C 25/323; C08G 63/20; F16L 59/02

(52) U.S. Cl. CPC C09D 167/02; C03C 13/06; C03C 25/323; C08G 63/20; F16L 59/026; F16L 59/028

(57) ABSTRACT

A fibrous insulation product with an extended uncured shelf life is disclosed comprising a plurality of randomly oriented fibers and a binder composition at least partially coating the fibers. The binder composition has a complex modulus at ambient temperature of no greater than 0.0004 MPa at a binder solids content of between 65% and 85%. The binder composition is free of added formaldehyde and is applied to the fibers as an aqueous binder composition comprising at least 20% by weight of a reactive diluent polyol, at least 30% by weight of a polymeric crosslinking agent comprising at least two carboxylic acid groups; and optionally, a protective agent. The reactive diluent polyol is substantially in liquid form at a solids content above 70% at ambient temperature.

### CROSS-REFERENCE TO RELATED APPLICATIONS

This application claims priority to and any benefit of U.S. Provisional Application No. 63/727,327, filed Dec. 3, 2024, the content of which is incorporated herein by reference in its entirety.

### BACKGROUND

Aqueous binder compositions are conventionally utilized in the formation of woven and non-woven fibrous products, such as insulation products, composite products, wood fiber board, and the like. Insulation products, for example insulation products formed of inorganic fibers, are typically manufactured by fiberizing a molten glass or mineral-based composition and spinning fibers from a fiberizing apparatus. To form an insulation product, a binder material is sprayed onto the fibers and the fibers are collected into a high loft, continuous blanket on the conveyor. The binder material gives the insulation product resiliency for recovery after packaging and provides stiffness and handleability so that the insulation product can be handled and applied as needed in the insulation cavities of buildings. The binder composition also provides protection to the fibers from interfilamentous abrasion and promotes compatibility between the individual fibers. The blanket containing the binder-coated fibers is then passed through a curing oven and the binder is cured to set the blanket to a desired thickness.

After the binder has cured, the fiber insulation may be cut into lengths to form individual insulation products, and the insulation products may be packaged for shipping to customer locations. Insulation products prepared in this manner can be provided in various forms including batts, blankets, and boards (heated and compressed batts) for use in different applications.

Alternatively, the formed, uncured blanket, containing the binder-coated fibers, can be further rolled up in a winding machine to form rolls or logs that are stored and later cured. The uncured rolls or logs can be stored for multiple days, before they are cut into proper lengths and formed into desired shape before curing, to better fit equipment and end application configurations such as pipe, partition walls, headliners, and hood liners. This long storage time is needed, for example, to meet plant operation scheduling needs. As a result, the uncured rolls or logs of insulation can require a longer shelf life during this storage period.

Mineral fiber products generally comprise man-made vitreous fibers (MMVF), such as glass fibers, ceramic fibers, basalt fibers, slag wool, mineral wool, and stone wool, which are bound together by a polymeric binder composition. Traditional binder compositions used for mineral fiber insulation, and particularly mineral wool insulation, are based on phenol-formaldehyde (PF) resins, as well as PF resins extended with urea (PUF resins). However, while such binder compositions provide suitable properties to the insulation products, formaldehyde binders emit undesirable emissions during the manufacturing process and there has been a desire to move away from the use of formaldehyde-based binders.

As an alternative to formaldehyde-based binders, certain formaldehyde-free or no added formaldehyde (“NAF”) formulations have been developed for use as binders in insulation products. Such NAF formulations may include a polycarboxylic acid and a polyol or polyhydroxy that are intended to crosslink via an esterification reaction.

Conventional NAF binder compositions can present challenges when used to form insulation required to have a longer shelf life (i.e., at least two days) before it is cured. Conventional formaldehyde-based binder systems would allow for such storage and would retain softness and flexibility throughout the roll. However, NAF binders have proven more difficult in this type of situation, since, for instance, the outer layer of the formed roll tends to dry out when stored prior to curing, making the roll too rigid and causes the uncured blanket to break while being formed into a desired shape (e.g., pipe). This also causes the layers of the insulation to stick together, thus requiring longer processing times, all decreasing productivity and efficiency, as well as the performance of the final insulation product.

Furthermore, although the outer layer of the formed roll tends to dry out more quickly, merely increasing moisture amounts can result in insulation rolls that are not uniform, as moisture increases tension of the uncured blanket, which then forms wrinkles and bubbles during rolling.

Prior attempts to maintain adequate moisture in the outer layer of an insulation roll during uncured storage include, for example, increasing the amount of water in the binder. However, increasing the water content of a binder composition results in increased moisture among the inner layers of the roll as well, which causes curing inconsistencies and impedes downstream cutting. Additional prior attempts have included adding more binder to the fibers and increasing the loss on ignition or “LOI” (the measure of how much binder is applied to fiber products, measured by the weight difference after burning off the organic binder components). However, increasing LOI causes stickiness, bubbling, and wrinkling of the insulation while it is undergoing winding, decreasing the quality of the shape formed.

Accordingly, an improved NAF binder composition is needed for use in the production of fibrous insulation products that require storage in the uncured state for an extended period of time (i.e., at least two days) or when a longer shelf life of the uncured insulation is otherwise desired, while also maintaining the product's mechanical strengths and adhesive properties similar to those of PUF and other NAF binders.

### SUMMARY

Various exemplary aspects of the present invention are directed to a fibrous insulation product with an extended uncured shelf life. The fibrous insulation product includes a plurality of randomly oriented fibers and a binder composition at least partially coating the fibers. The binder composition has a complex modulus of no greater than 0.0004 MPa at a binder solids content of between 65% and 85%. The binder composition is free of added formaldehyde and is applied to the fibers as an aqueous binder composition comprising at least 20% by weight of a reactive diluent polyol, at least 30% by weight of a polymeric crosslinking agent comprising at least two carboxylic acid groups, and optionally, a protective agent. If present, the protective agent may comprise an ammonium-based protective agent in an amount from 1.25 wt. % to 20 wt. %, based on the total weight of the aqueous binder composition. The reactive diluent polyol is substantially in liquid form at a solids content above 70%, and in some aspects, above 95%, at ambient temperature. The binder composition is included in the fibrous insulation product at an LOI (loss on ignition) of 0.5 to 4%.

The reactive diluent polyol may comprise, for example, glycerol, polyglycerol, propylene glycol, ethylene glycol, diethylene glycol, polyethylene glycol, triethanolamine, 1,3-butanediol, or mixtures thereof. In particularly preferred aspects, the reactive diluent polyol comprises glycerol, polyglycerol, or mixtures thereof.

The reactive diluent polyol is included in the binder composition in an amount from 25 wt. % to 65 wt. %, such as, for example, 30 wt. % to 45 wt. %, and 35 wt. % to 50 wt. %, including all endpoints and subranges therebetween.

In some aspects, the binder composition further optionally includes a secondary polyol comprising one or more of a sugar alcohol, pentaerythritol, and alkanolamine. The secondary polyol, if present, is included in the binder composition in an amount less than 30 wt. %.

The aqueous binder composition has a complex modulus below 0.0008 MPa, and in some aspects below 0.0004 MPa, at a binder premix solids percentage of at least 70%.

The fibrous insulation product may comprise any of a mineral wool insulation product, a glass fiber insulation product, and mixtures thereof. In some aspects, the fibrous insulation product comprises pipe insulation.

Other aspects of the invention are directed to an aqueous binder composition for forming a fibrous insulation product with an extended uncured shelf life. The binder composition, at a solids content of at least 70%, demonstrates an impinge resistance after exposure to ambient conditions for 120 hours of less than 0.3 mm and a complex modulus of less than 0.0008 MPa. The binder composition is free of added formaldehyde and comprises at least 20% by weight of a reactive diluent polyol and at least 30% by weight of a polymeric crosslinking agent comprising at least two carboxylic acid groups. The reactive diluent polyol is substantially in liquid form at a solids content above 70%, and in some aspects, above 95% at ambient temperature

As mentioned above, the reactive diluent polyol comprises glycerol, polyglycerol, propylene glycol, ethylene glycol, diethylene glycol, polyethylene glycol, triethanolamine, 1,3-butanediol, or mixtures thereof.

Yet further aspects of the invention are directed to a method for extending the uncured shelf life of an insulation product formed with a binder composition. The method includes forming an uncured insulation blanket from a plurality of randomly oriented fibers at least partially coated with an aqueous binder composition and curing the insulation blanket to form a fibrous insulation product. The aqueous binder composition comprises at least 20% by weight of a reactive diluent polyol and at least 30% by weight of a polymeric crosslinking agent comprising at least two carboxylic acid groups. The reactive diluent polyol is substantially in liquid form at a solids content above 70% at ambient temperature. The aqueous binder composition has a complex modulus of no greater than 0.0008 MPa at a solids content of at least 70%. In some aspects, the step of curing the insulation occurs after at least two days. In any aspect, the insulation blanket may maintain a complex modulus of no greater than 0.0008 MPa at a solids content of at least 70% after at least 2 days, or even after 5 days.

Numerous other aspects, advantages, and/or features of the general inventive concepts will become more readily apparent from the following detailed description of exemplary embodiments and from the accompanying drawings being submitted herewith.

### BRIEF DESCRIPTION OF THE DRAWINGS

The general inventive concepts, as well as illustrative embodiments and advantages thereof, are described below in greater detail, by way of example, with reference to the drawings in which:

FIG. 1 illustrates a typical method for producing a mineral wool mat or blanket according to the present invention.

FIG. 2 illustrates an exemplary method for forming a blanket comprising binder-coated fibers into rolls or logs of insulation before curing, for example pipe insulation, according to the present invention.

FIG. 3 graphically illustrates an effect that increasing the percent of binder solids in various binder systems has on binder complex modulus.

FIG. 4 illustrates the effect that including a reactive diluent polyol as described herein has on binder droplet size and shape (moisture content).

FIG. 5 graphically illustrates the complex modulus (MPa) as a function of percent binder solids of an exemplary binder composition (in accordance with the inventive concepts herein) compared to an otherwise comparable binder composition that does not comprise a reactive diluent polyol.

FIG. 6 graphically illustrates the viscosity of various binder compositions over increasing solids contents (percent solids).

### DETAILED DESCRIPTION

Unless otherwise defined, all technical and scientific terms used herein have the same meaning as commonly understood by one of ordinary skill in the art to which these exemplary embodiments belong. The terminology used in the description herein is for describing exemplary embodiments only and is not intended to be limiting of the exemplary embodiments. Accordingly, the general inventive concepts are not intended to be limited to the specific embodiments illustrated herein. Although other methods and materials similar or equivalent to those described herein can be used in the practice or testing of the present invention, the preferred methods and materials are described herein.

As used in the specification and the appended claims, the singular forms “a,” “an,” and “the” are intended to include the plural forms as well, unless the context clearly indicates otherwise.

By “substantially free” it is meant that a composition includes less than 1.0 wt. % of the recited component, including no greater than 0.8 wt. %, no greater than 0.6 wt. %, no greater than 0.4 wt. %, no greater than 0.2 wt. %, no greater than 0.1 wt. %, and no greater than 0.05 wt. %. In any of the exemplary embodiments, “substantially free” means that a composition includes no greater than 0.01 wt. % of the recited component.

Unless otherwise indicated, all numbers expressing quantities of ingredients, chemical and molecular properties, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present exemplary embodiments. At the very least, each numerical parameter should be construed in light of the number of significant digits and ordinary rounding approaches.

Unless otherwise indicated, any element, property, feature, or combination of elements, properties, and features, may be used in any embodiment disclosed herein, regardless of whether the element, property, feature, or combination of elements, properties, and features was explicitly disclosed in the embodiment. It will be readily understood that features described in relation to any particular aspect described herein may be applicable to other aspects described herein provided the features are compatible with that aspect. In particular: features described herein in relation to the method may be applicable to the fibrous product and vice versa; features described herein in relation to the method may be applicable to the aqueous binder composition and vice versa; and features described herein in relation to the fibrous product may be applicable to the aqueous binder composition and vice versa.

Every numerical range given throughout this specification and claims will include every narrower numerical range that falls within such broader numerical range, as if such narrower numerical ranges were all expressly written herein.

The present disclosure relates to formaldehyde-free or “no added formaldehyde” aqueous binder compositions for use with inorganic fibers, such as glass or mineral wool fibers. As used herein, the terms “binder composition,” “aqueous binder composition,” “binder formulation,” “binder,” and “binder system’ may be used interchangeably and are synonymous. Additionally, as used herein, the terms “formaldehyde-free” or “no added formaldehyde” may be used interchangeably and are synonymous.

The binder composition may be used in the manufacture of fiber insulation products and related products, such as fiber-reinforced mats, veils, nonwovens, etc. (all hereinafter referred to generically as fibrous products). The binder composition may particularly be used with rock or mineral wool products, such as mineral wool insulation products, made with the cured binder composition, or with fiberglass insulation products. Other products may include composite products, wood fiber board products, metal building insulation, pipe insulation, ceiling board, ceiling tile, “heavy density” products, such as board products including, for example, ceiling board, duct board, foundation boards, pipe and tank insulation, sound absorption boards, acoustical panels, general board products, duct liners, and also “light density” products including, for example, residential insulation, duct wrap, metal building insulation, flexible duct media. Further fibrous products include non-woven fiber mats and particle boards, and composite products manufactured therefrom.

Although this disclosure will be described as mineral wool insulation herein, it should be noted that this disclosure applies to other inorganic fibrous insulation products, including but not limited to fiberglass insulation products.

The present inventive concepts are directed to improved formaldehyde-free binder compositions for use in the manufacture of insulation products capable of extended uncured shelf-life and methods for extending the uncured shelf-life of uncured insulation products with the use of particular binder compositions. The binder compositions demonstrate the ability to maintain a low complex modulus under high binder solid percentages or conditions (for example, binder solid percentages of about 50% to 90%) and/or for an extended period (such as up to 5 days or more), making the product capable of being used for downstream product forming processes, such as a pipe forming processes. Furthermore, the binder composition's low complex modulus eliminates wrinkling and bubbling during the winding process and reduces the sticking together of layers of insulation.

As used herein, the phrase “complex modulus” or (G*) is used to describe a quantitative measure of material stiffness or resistance to deformation and is the ratio of the applied stress (or strain) to the measured strain (or stress). Complex modulus (G*) is the sum of the storage modulus (G′) and the loss modulus (G″), wherein the loss modulus is multiplied with i, the imaginary unit (G*=G′+iG″). The complex modulus is calculated as the square root of the sum of G′² and G″²; with G′²=G′×G′; and G″²=G″×G″. G*=(G″²+G″²)^{0.5}

Storage modulus is a measurement of the stiffness of a material and loss modulus describes the damping behavior of the material using dynamic mechanical analysis (DMA).

Suitable fibers for use in the fibrous products of the present disclosure include, but are not limited to, mineral fibers (e.g., mineral wool, rock wool, stone wool, slag wool, and the like), glass fibers, carbon fibers, ceramic fibers, natural fibers, and synthetic fibers. In certain exemplary embodiments, the plurality of randomly oriented fibers are mineral wool or glass fibers, including, but not limited to mineral wool fibers, rock wool fibers, slag wool fibers, stone wool fibers, fiberglass, or combinations thereof.

The fibrous insulation products may be formed entirely of one type of fiber, or they may be formed of a combination of two or more types of fibers. For example, the insulation products may be formed of combinations of various types of mineral fibers or various combinations of different inorganic fibers and/or natural fibers depending on the desired application. In certain exemplary embodiments the insulation products are formed entirely of mineral wool fibers.

Binder compositions are typically applied to the fibers as an aqueous solution or dispersion shortly after the fibers are formed. The binders are then cured at elevated temperatures, or curing occurs after the insulation products undergo storage for a period of time. As used herein, “dispersion” includes all forms of solids dispersed in a liquid medium, regardless of the size of the particle or properties of the dispersion, including true “solutions” in which the solids are soluble and dissolved in the liquid medium. The curing conditions of the binder composition are selected both to evaporate any remaining solvent and cure the binder to a thermoset state. The fibers in the resulting product tend to be at least partially coated with a thin layer of the thermoset resin and exhibit accumulations of the binder composition at points where fibers touch or are positioned closely adjacent to each other.

Conventional NAF binder compositions include, for example, those formed via an esterification reaction between at least one polyacid and at least one polyol. However, as mentioned above, the outer layers of uncured rolled fibrous insulation products formed with conventional NAF binders have shown to dry out when stored, making the roll too rigid and subject to breakage while being formed into a desired shape (e.g., pipe).

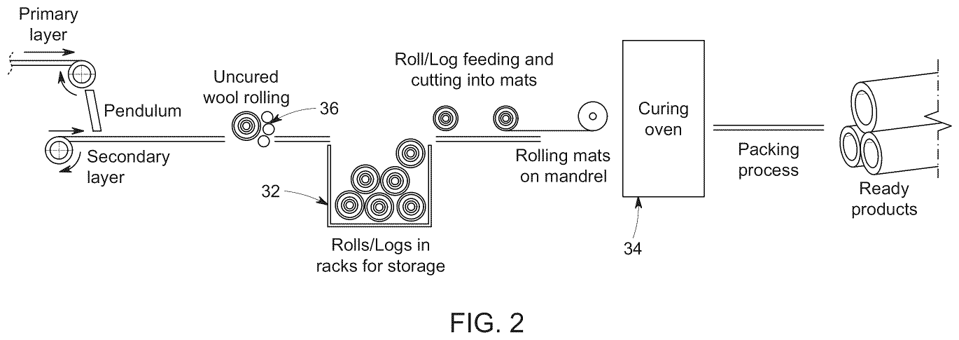

However, it has been surprisingly discovered that certain polyols, when used in particular concentrations and ratios, improve the processability of a resulting fibrous insulation product and enable extended uncured shelf-life, as compared with conventional NAF binder compositions. Particularly, the inclusion of a reactive diluent polyol in an NAF binder composition lowers the binder's complex modulus for an extended period of time, even under high binder solid percentages. The improved binder composition results in a product capable of being used in downstream forming processes, such as a pipe forming/winding process as illustrated by FIG. 2. The low complex modulus under high binder solids substantially reduces or eliminates wrinkling and bubbling in the winding process and avoids sticking, while also avoiding an increase in moisture among the inner layers of the roll.

The novel binder composition disclosed herein extends the shelf life of an uncured insulation product, while also lowering the binder's impinge resistance and increasing the healing time of insulation products formed with the binder composition. Preferably, an insulation product binder composition has little-to-no skin formation while uncured, but is pliable enough to hold together under stress. A binder skin healing test may be used to analyze how a binder reacts to a material being impinged in it that is then retracted quickly. The subject binder composition provides an improvement in the impinge resistance and healing times of the insulation product (i.e., reduced or eliminated skin formation), compared to insulation products manufactured using otherwise comparable binder compositions that do not include a certain minimum amount of a reactive diluent polyol.

As mentioned above, the binder composition includes at least one reactive diluent polyol. The phrase ‘reactive diluent polyol,” as used herein, refers to a polyol that remains substantially in liquid form at high solids contents and ambient temperature (15° C.-20° C.). The term “substantially,” as used herein, means at least 75%, and in some instances, at least 85%, and in some instances, at least 95%, and in yet other instances, 100%. Particularly, the reactive diluent polyol is substantially in liquid form at a solids content of above 70%. In any of the exemplary aspects, the reactive diluent polyol is substantially in liquid form at a solids content of 75% and above, including, for example, at a solids content of 80% and above, at a solids content of 85% and above, at a solids content of 90% and above, at a solids content of 95% and above, and a solids content of 100%. In contrast, conventional NAF binder compositions have been manufactured using, for example, sorbitol which remains in liquid form at a maximum solids content of 70%.

Exemplary reactive diluent polyols include glycerol, polyglycerol, propylene glycol, ethylene glycol, diethylene glycol, polyethylene glycol, triethanolamine, 1,3-butanediol, and mixtures thereof. In any of the exemplary embodiments, the reactive diluent polyol comprises glycerol and/or polyglycerol. In accordance with certain aspects, the binder composition may comprise reactive diluents glycerol, polyglycerol, or combinations thereof as primary diluents, and one or more secondary diluents comprising ethylene glycol, propylene glycol, diethylene glycol, 1,3-butanediol, or combinations thereof.

The reactive diluent polyol has a higher mol-equivalent weight per OH group than sorbitol, which has a mol-equivalent weight of 30.33. Therefore, the reactive diluent polyol provides a binder composition with the advantage of a lower viscosity at the same solids content, or requires less moisture content to achieve the same viscosity as conventional polyols, such as sorbitol. Additionally, the weight ratio of crosslinking agent, such as polyacrylic acid, can be proportionally reduced by the increased mol-equivalent weight of the reactive diluent polyol, without adversely affecting the COOH:OH ratio. In particular, the reactive diluent polyol has a mol-equivalent weight per OH group that is greater than 35, such as, for example, a mol-equivalent weight per OH group of at least 40, at least 42, at least 45, at least 50, at least 55, at least 75, at least 100, at least 125, at least 150, at least 175, and at least 200. With specific reference to polyglycerol, for example, polyglycerol a mol-equivalent weight per OH group of between about 40 and 55, such as about 41.5, 48, 52.33, or 55.4, respectively, assuming an average degree polymerization of 2, 3, 4, or 5).

In any of the embodiments disclosed herein, the binder composition may include the reactive diluent polyol in an amount of at least 10 wt. %, including, for example, an amount of at least 12 wt. %, at least 15 wt. %, at least 20 wt. %, at least 25 wt. %, at least 30 wt. %, at least 35 wt. %, at least 37 wt. %, and at least 40 wt. %. Such amounts include a concentration of reactive diluent polyol in the binder composition that includes from 15 to 70 wt. %, based on the total solids in the binder composition, including without limitation, an amount from 20 wt. % to 65 wt. %, 22 wt. % to 60 wt. %, 23 wt. % to 55 wt. %, 25 wt. % to 50 wt. %, 27 wt. % to 47 wt. %, 30 wt. % to 45 wt. %, and 35 wt. % to 42 wt. %, including all endpoints and subranges therebetween.

As mentioned above, aspects of the technical effect are achieved through the use of at least 10 wt. % of a reactive diluent polyol that is substantially in liquid form at a solids content of above 70%, in combination with a polymeric crosslinking agent comprising at least two carboxylic acid groups. In any of the exemplary embodiments, the crosslinking agent may be a low molecular weight polymeric crosslinking agent. In such embodiments, the low molecular weight polymeric crosslinking agent may have a number-average molecular weight of less than or equal to 5,000 Daltons, including crosslinking agents having number-average molecular weights of less than or equal to 4,000 Daltons, less than or equal to 3,500 Daltons, less than or equal to 3,000 Daltons, less than or equal to 2,500 Daltons, less than or equal to 2,250 Daltons, less than or equal to 2,000 Daltons, less than or equal to 1,750 Daltons, less than or equal to 1,500 Daltons, and less than or equal to 1,250 Daltons. In any of the exemplary embodiments, the reactive diluent polyol has a number-average molecular weight of 900 Daltons to 1,100 Daltons. The number-average molecular weight may be measured by gel permeation chromatography (GPC).

Non-limiting examples of suitable crosslinking agents include materials having one or more carboxylic acid groups (—COOH), such as monomeric and polymeric polycarboxylic acids, including salts or anhydrides thereof, and mixtures thereof. In any of the exemplary embodiments, the polycarboxylic acid may be a polymeric polycarboxylic acid, such as a homopolymer or copolymer of acrylic acid. The polymeric polycarboxylic acid may comprise polyacrylic acid (including salts or anhydrides thereof) and polyacrylic acid-based resins.

In any of the exemplary embodiments disclosed herein, the crosslinking agent may be present in the binder composition in an amount of at least 20 wt. %, based on the total solids content of the binder composition, including, without limitation at least 30 wt. %, at least 33 wt. %, at least 35 wt. %, at least 38 wt. %, at least 40 wt. %, at least 41 wt. %, at least 43 wt. %, at least 45 wt. %, at least 47 wt. %, and at least 50 wt. %. In any of the exemplary embodiments, the low molecular weight crosslinking agent may be present in the binder composition in an amount from 30% to 75% by weight, based on the total solids content of the binder composition, including without limitation 35% to 65% by weight, 37% to 60% by weight, and 40% to 58% by weight, including all endpoints and sub-combinations therebetween.

With regard to mineral wool fibers specifically, it has surprisingly been discovered that all or a percentage of the acid functionality in the low molecular weight crosslinking agent may be temporarily blocked with the use of a protective agent, which temporarily blocks the acid functionality from complexing with the mineral wool fibers, and is subsequently removed by heating the binder composition to a temperature of at least 150° C., freeing the acid functionalities to crosslink with the polyol component and complete the esterification process, during the curing process. In any of the exemplary embodiments, 10% to 100% of the carboxylic acid functional groups may be temporarily blocked by the protective agent, including between 25% to 99%, 30% to 90%, and 40% to 85%, including all subranges and combinations of ranges therebetween. In any of the exemplary embodiments, a minimum of 40% of the acid functional groups may be temporarily blocked by the protective agent.

The protective agent may be capable of reversibly bonding to the carboxylic acid groups of the crosslinking agent. In any of the exemplary embodiments, the protective agent comprises any compound comprising molecules capable of forming at least one reversible ionic bond with a single acid functional group. In any of the exemplary embodiments disclosed herein, the protective agent may comprise a nitrogen-based protective agent, such as an ammonium-based protective agent; an amine-based protective agent; or mixtures thereof. An exemplary ammonium based protective agent includes ammonium hydroxide. Exemplary amine-based protective agents include alkylamines and diamines, such as, for example ethyleneimine, ethylenediamine, hexamethylenediamine; alkanolamines, such as: ethanolamine, diethanolamine, triethanolamine; ethylenediamine-N,N′-disuccinic acid (EDDS), ethylenediaminetetraacetic acid (EDTA), and the like, or mixtures thereof. In addition, the alkanolamine can be used as both a protecting agent and as a participant in the crosslinking reaction to form ester in the cured binder. Thus, the alkanolamine has a dual-functionality of protective agent and polyol for crosslinking with the polycarboxylic acid via esterification.

Moreover, along with providing a temporary blocking function, the protective agent also increases the pH of the binder composition to provide compatibility with the pH of the mineral wool fiber. If the pH of the binder composition is significantly lower than the pH of the fiber, the binder composition can damage the mineral fiber, which changes the composition and weakens the fiber. The function of the binder composition is to adhere the fibers together and should not react with the fiber itself.

The pH of the binder composition in an un-cured state may be adjusted depending on the intended application, to facilitate the compatibility of the ingredients of the binder composition, or to function with various types of fibers. In any of the exemplary embodiments disclosed herein, when in an un-cured state, the pH of the binder composition has a pH of at least about 5. In such exemplary embodiments, the pH of the binder composition, when in an un-cured state, may be about 5.0-7.0, including between 5.2 and 6.8, and between 5.5 and 6.5. After cure, the pH of the binder composition may rise to at least a pH of 6.5 and up to pH of 8.5. In any of the exemplary embodiments disclosed herein, the cured pH of the binder composition is between 7.2 and 7.8.

If present, the protective agent may be present in the binder composition in an amount from 0.25 wt. % to 20 wt. %, based on the total solids in the binder composition, including without limitation, amounts from 1.5 wt. % to 15 wt. %, or from 2 wt. % to 10 wt. %, 3 wt. % to 8 wt. %, and all endpoints and subranges therebetween. In any of the exemplary embodiments disclosed herein, when included, the protective agent is present in the binder composition in at least 1.5 wt. %, including at least 2 wt. %, at least 3 wt. %, at least 4 wt. %, and at least 5 wt. %. In any of the exemplary embodiments, the protective agent may be used in an amount sufficient to block at least 40% of the acid functional groups of the polycarboxylic acid.

Optionally, the binder composition may further include at least one polyol having two or more hydroxyl groups (also referred to herein as a polyhydroxy compound), that is distinct from the reactive diluent polyol introduced above (also referred to herein as a secondary polyol). In any of the exemplary embodiments, the secondary polyol may comprise one or more of monomeric or polymeric polyhydroxy compounds.

Exemplary secondary polyols include pentaerythritol, alkanolamines, mixtures thereof, or derivatives thereof. In any of the exemplary embodiments, the alkanolamine may comprise triethanolamine, or derivatives thereof. Accordingly, in some exemplary embodiments, the polyol comprises one or more of pentaerythritol, triethanolamine, derivatives thereof, or mixtures thereof.

Alternatively, or in addition to the above, the secondary polyol may comprise one or more sugar alcohols. Sugar alcohol is understood to mean compounds obtained when the aldo or keto groups of a sugar are reduced (e.g. by hydrogenation) to the corresponding hydroxy groups. The starting sugar might be chosen from monosaccharides, oligosaccharides, and polysaccharides, and mixtures of those products, such as syrups, molasses and starch hydrolyzates. The starting sugar also could be a dehydrated form of a sugar. Although sugar alcohols closely resemble the corresponding starting sugars, they are not sugars. Thus, for instance, sugar alcohols have no reducing ability, and cannot participate in the Maillard reaction typical of reducing sugars. In any of the exemplary embodiments, the sugar alcohol includes any of glycerol, erythritol, arabitol, xylitol, sorbitol, maltitol, mannitol, iditol, isomaltitol, lactitol, cellobitol, palatinitol, maltotritol, syrups thereof, and mixtures thereof. In various exemplary embodiments, the sugar alcohol is selected from glycerol, sorbitol, xylitol, and mixtures thereof. In any of the exemplary embodiments, the polyol may be a dimeric or oligomeric condensation product of a sugar alcohol. In any of the exemplary embodiments, the condensation product of a sugar alcohol may be isosorbide. In any of the exemplary embodiments, the sugar alcohol may be a diol or glycol.

In any of the exemplary embodiments, the binder composition may be free of reducing sugars. A reducing sugar is a type of carbohydrate or sugar that includes a free aldehyde or ketone group and can donate electrons to another molecule. As the binder composition is free of reducing sugars, it is unable to participate in a Maillard reaction, which is a process that occurs when a reducing sugar reacts with an amine. The Maillard reaction results in a binder composition with a brown color, which is undesirable for the subject binder composition.

In any of the exemplary embodiments, the secondary polyol may include at least one carbohydrate that is natural in origin and derived from renewable resources. For instance, the carbohydrate may be derived from plant sources such as legumes, maize, corn, waxy corn, sugar cane, milo, white milo, potatoes, sweet potatoes, tapioca, rice, waxy rice, peas, sago, wheat, oat, barley, rye, amaranth, and/or cassava, as well as other plants that have a high starch content. The carbohydrate may also be derived from crude starch-containing products derived from plants that contain residues of proteins, polypeptides, lipids, and low molecular weight carbohydrates. The carbohydrate may be selected from monosaccharides (e.g., xylose, glucose, and fructose), disaccharides (e.g., sucrose, maltose, and lactose), oligosaccharides (e.g., glucose syrup and fructose syrup), and polysaccharides and water-soluble polysaccharides (e.g., pectin, dextrin, maltodextrin, starch, modified starch, and mixtures thereof).

The carbohydrate may be a carbohydrate polymer having a number average molecular weight from about 1,000 to about 8,000, measured using GPC/SEC or GC analysis. Additionally, the carbohydrate polymer may have a dextrose equivalent (DE) number from 2 to 20, from 7 to 11, or from 9 to 14. In at least one exemplary embodiment, the carbohydrate is a water-soluble polysaccharide such as dextrin or maltodextrin.

The secondary polyol may be present in the binder composition in an amount up to about 30% by weight total solids, including without limitation, up to about 25%, about 20%, about 15%, about 12%, and about 10% by weight total solids. In any aspect, the secondary polyol may be present in the binder composition in an amount from 0% to about 30% by weight total solids, including without limitation 2% to 25%, 3% to 20%, 5% to 18%, 8% to 15%, and 10% to 25%, by weight total solids, including all endpoints and sub-combinations therebetween.

According to any aspect, the cross-linking agent, reactive diluent polyol, and any optional secondary polyols may be present in amounts such that the ratio of the number of molar equivalents of carboxylic acid groups, anhydride groups, or salts thereof to the number of molar equivalents of hydroxyl groups (COOH:OH) is from about 0.07:1 to about 2.23:1, such as from about 0.17:1 to about 1:0.6, or from about 0.32:1 to about 0.92:1, or from about 0.4:1 to 0.6:1. In any of the exemplary embodiments, the aqueous binder composition may have a ratio of molar equivalents of carboxylic acid groups to hydroxyl groups that may be between 1:3 to 3:1, or between 0.60:1.0 and 1.0:0.6, or between 0.80:1 and 1.0:0.80. In certain aspects, the COOH:OH molar ratio is less than 1:1, including, for example, 1:1.1, 1:1.2, 1:1.3, 1:1.4, 1:1.5, and so on.

The COOH:OH molar equivalent ratio is important to provide a binder composition with a reduced level of water-soluble material post-cure, as determined by extracting water-soluble materials with deionized water for 2 hours at room temperature using about 1000 g of deionized water per about 1 gram of binder. The presence of water-soluble material post cure is indicative of incomplete curing and therefore weakened product properties, such as tensile strength and complex modulus. Additionally, the higher the level of water-soluble material after cure, the more likely it is that a cured material suffers from leaching if/when exposed to water and/or a hot/humid environment. According to some aspects, the binder composition has no greater than 10% by weight of water-soluble material after cure. In some aspects, the binder composition has less than 6% by weight water-soluble material after cure, including less than 5.5% by weight, 5.0% by weight, 4.0 wt. %, 3.0% by weight, less than 2.5% by weight, less than 2.0% by weight less than 1.5% by weight, or less than 1.0% by weight. It has been discovered that reducing the level of water-soluble material after cure to no greater than 10% by weight, and preferably no greater than 6.0% by weight, will improve the tensile strength of insulation products formed binder composition, as compared to an otherwise similar binder composition having a higher amount water soluble material after cure.

Optionally, the binder composition may include an esterification catalyst, also known as a cure accelerator. The catalyst may include inorganic salts, Lewis acids (i.e., aluminum chloride or boron trifluoride), Bronsted acids (i.e., sulfuric acid, p-toluenesulfonic acid and boric acid) organometallic complexes (i.e., lithium carboxylates, sodium carboxylates), and/or Lewis bases (i.e., polyethyleneimine, diethylamine, or triethylamine). Additionally, the catalyst may include an alkali metal salt of a phosphorous-containing organic acid, such as hypophosphorus acid; in particular, alkali metal salts of phosphorus acid, hypophosphorus acid, or polyphosphoric. Examples of such phosphorus catalysts include, but are not limited to, sodium hypophosphite, sodium phosphate, potassium phosphate, disodium pyrophosphate, tetrasodium pyrophosphate, sodium tripolyphosphate, sodium hexametaphosphate, potassium phosphate, potassium tripolyphosphate, sodium trimetaphosphate, sodium tetrametaphosphate, and mixtures thereof. In addition, the catalyst or cure accelerator may be a fluoroborate compound such as fluoroboric acid, sodium tetrafluoroborate, potassium tetrafluoroborate, calcium tetrafluoroborate, magnesium tetrafluoroborate, zinc tetrafluoroborate, ammonium tetrafluoroborate, and mixtures thereof. Further, the catalyst may be a mixture of phosphorus and fluoroborate compounds. Other sodium salts such as, sodium sulfate, sodium nitrate, sodium carbonate may also or alternatively be used as the catalyst.

The catalyst may be present in the binder composition in an amount from 0 to 10% by weight of the total solids in the binder composition, including without limitation, amounts from 0 to 5 wt. %, or from 0.5 wt. % to 4.5 wt. % by weight, or from 1.0 wt. % to 4.0 wt. %, or from 1.15 wt. % to 3.8 wt. %. The binder composition may further include a pH adjuster, in an amount of 0 to 10.0 wt. % based on the total solids content of the binder composition.

The binder composition may further include one or more surfactants to assist in binder atomization, wetting, and interfacial adhesion. If present, the surfactant may be included in the binder composition in an amount from 0 to 10 wt. %, including without limitation, amounts from 0.1 wt. % to 5.0 wt. %, or from 0.15 wt. % to 2.0 wt. %, or from 0.2 wt. % to 1.0 wt. %, based on the total solids content in the binder composition. The surfactant is not particularly limited, and includes surfactants such as, but not limited to, ionic surfactants (e.g., sulfate, sulfonate, phosphate, and carboxylate); sulfates (e.g., alkyl sulfates, ammonium lauryl sulfate, sodium lauryl sulfate (SDS), alkyl ether sulfates, sodium laureth sulfate, and sodium myreth sulfate); amphoteric surfactants (e.g., alkylbetaines such as lauryl-betaine); sulfonates (e.g., dioctyl sodium sulfosuccinate, perfluorooctanesulfonate, perfluorobutanesulfonate, and alkyl benzene sulfonates); phosphates (e.g., alkyl aryl ether phosphate and alkyl ether phosphate); carboxylates (e.g., alkyl carboxylates, fatty acid salts (soaps), sodium stearate, sodium lauroyl sarcosinate, carboxylate fluorosurfactants, perfluoronanoate, and perfluorooctanoate); cationic (e.g., alkylamine salts such as laurylamine acetate); pH dependent surfactants (primary, secondary or tertiary amines); permanently charged quaternary ammonium cations (e.g., alkyltrimethylammonium salts, cetyl trimethylammonium bromide, cetyl trimethylammonium chloride, cetylpyridinium chloride, and benzethonium chloride); and zwitterionic surfactants, quaternary ammonium salts (e.g., lauryl trimethyl ammonium chloride and alkyl benzyl dimethylammonium chloride), polyoxyethylenealkylamines, and mixtures thereof.

Suitable nonionic surfactants that can be used in conjunction with the binder composition include polyethers (e.g., ethylene oxide and propylene oxide condensates, which include straight and branched chain alkyl and alkaryl polyethylene glycol and polypropylene glycol ethers and thioethers); alkylphenoxypoly(ethyleneoxy) ethanols having alkyl groups containing from about 7 to about 18 carbon atoms and having from about 4 to about 240 ethyleneoxy units (e.g., heptylphenoxypoly(ethyleneoxy) ethanols, and nonylphenoxypoly(ethyleneoxy) ethanols); polyoxyalkylene derivatives of hexitol including sorbitans, sorbides, mannitans, and mannides; partial long-chain fatty acids esters (e.g., polyoxyalkylene derivatives of sorbitan monolaurate, sorbitan monopalmitate, sorbitan monostearate, sorbitan tristearate, sorbitan monooleate, and sorbitan trioleate); condensates of ethylene oxide with a hydrophobic base, the base being formed by condensing propylene oxide with propylene glycol; sulfur containing condensates (e.g., those condensates prepared by condensing ethylene oxide with higher alkyl mercaptans, such as nonyl, dodecyl, or tetradecyl mercaptan, or with alkylthiophenols where the alkyl group contains from about 6 to about 15 carbon atoms); ethylene oxide derivatives of long-chain carboxylic acids (e.g., lauric, myristic, palmitic, and oleic acids, such as tall oil fatty acids); ethylene oxide derivatives of long-chain alcohols (e.g., octyl, decyl, lauryl, or cetyl alcohols); and ethylene oxide/propylene oxide copolymers.

The surfactants may include one or more of Dynol 607, which is a 2,5,8,11-tetramethyl-6-dodecyne-5,8-diol, SURFONYL® 420, SURFONYL® 440, and SURFONYL® 465, which are ethoxylated 2,4,7,9-tetramethyl-5-decyn-4,7-diol surfactants (commercially available from Evonik Corporation (Allentown, Pa.)), Stanfax (a sodium lauryl sulfate), Surfynol 465 (an ethoxylated 2,4,7,9-tetramethyl 5 decyn-4,7-diol), Triton™ GR-PG70 (1,4-bis(2-ethylhexyl) sodium sulfosuccinate), and Triton™ CF-10 (poly(oxy-1,2-ethanediyl), alpha-(phenylmethyl)-omega-(1,1,3,3-tetramethylbutyl) phenoxy).

Optionally, the binder composition may contain a dust suppressing agent to reduce or eliminate the presence of inorganic and/or organic particles which may have adverse impact in the subsequent fabrication and installation of the insulation materials. The dust suppressing agent can be any conventional mineral oil, mineral oil emulsion, natural or synthetic oil, bio-based oil, or lubricant, such as, but not limited to, silicone and silicone emulsions, polyethylene glycol, as well as any petroleum or non-petroleum oil with a high flash point to minimize the evaporation of the oil inside the oven.

In any of the exemplary embodiments, the binder composition may include up to 15 wt. % of a dust suppressing agent, including up to 12 wt. %, or up to 10 wt. %. In any of the exemplary embodiments, the binder composition may include between 0 wt. % and 15 wt. % of a dust suppressing agent, including 1 wt. % to 13 wt. %, 2 wt. % to 11 wt. %, 4 wt. % to 9 wt. %, or 5 wt. % to 8 wt. %, including all endpoints and subranges therebetween.

Optionally, the binder composition may include one or more processing aids. The processing aid is not particularly limiting so long as the process aid functions to facilitate the processing of the fiber formation and orientation. The process aid can be used to improve binder application distribution uniformity, to reduce binder viscosity, to increase ramp height after forming, to improve the vertical weight distribution uniformity, and/or to accelerate binder de-watering in both forming and oven curing process. The process aid may be present in the binder composition in an amount from 0 to 15 wt. %, including without limitation, amounts from 0.5 wt. % to 10 wt. %, or from 1 wt. % to 7 wt. % by weight, or from 1.5 wt. % to 5 wt. %, based on the total solids content in the binder composition. In any of the exemplary embodiments, the aqueous binder composition may be substantially or completely free of any processing aids.

Examples of processing aids include defoaming agents, such as, silicone, emulsions and/or dispersions of silicone, dispersions of polydimethylsiloxane (PDMS) fluids, and silica which has been hydrophobized with polydimethylsiloxane or other materials. Further processing aids may include particles made of amide waxes such as ethylenebis-stearamide (EBS) or hydrophobized silica.

Optionally, the binder composition may contain at least one coupling agent. In at least one exemplary embodiment, the coupling agent is a silane coupling agent. The coupling agent(s) may be present in the binder composition in an amount from 0.01 wt. % to 5 wt. % by weight of the total solids in the binder composition, including without limitation, amounts from 0.01 wt. % to 2.5 wt. %, from 0.05 wt. % to 1.5 wt. %, or from 0.1 wt. % to 1 wt. %.

Non-limiting examples of silane coupling agents that may be used in the binder composition may be characterized by the functional groups alkyl, aryl, amino, epoxy, vinyl, methacryloxy, ureido, isocyanato, and mercapto. In exemplary embodiments, the silane coupling agent(s) include silanes containing one or more nitrogen atoms that have one or more functional groups such as amine (primary, secondary, tertiary, and quaternary), amino, imino, amido, imido, ureido, or isocyanato. Specific, non-limiting examples of suitable silane coupling agents include, but are not limited to, aminosilanes (e.g., triethoxyaminopropylsilane; 3-aminopropyl-triethoxysilane and 3-aminopropyl-trihydroxy silane), epoxy trialkoxysilanes (e.g., 3-glycidoxypropyltrimethoxysilane and 3-glycidoxypropyltriethoxysilane), methyacryl trialkoxysilanes (e.g., 3-methacryloxypropyltrimethoxysilane and 3-methacryloxypropyltriethoxysilane), hydrocarbon trialkoxysilanes, amino trihydroxysilanes, epoxy trihydroxysilanes, methacryl trihydroxy silanes, and/or hydrocarbon trihydroxysilanes. In one or more exemplary embodiment, the silane is an aminosilane, such as γ-aminopropyltriethoxysilane.

The binder composition further includes water to dissolve or disperse the active solids for application onto the reinforcement fibers. Water may be added in an amount sufficient to dilute the binder composition to a viscosity that is suitable for its application to the reinforcement fibers and to achieve a desired solids content on the fibers.

In any of the exemplary embodiments, the binder composition may also include one or more additives, such as an extender, a crosslinking density enhancer, a deodorant, an antioxidant, a biocide, a moisture resistant agent, or combinations thereof. Optionally, the binder may comprise, without limitation, dyes, pigments, additional fillers, colorants, UV stabilizers, thermal stabilizers, anti-foaming agents, emulsifiers, preservatives (e.g., sodium benzoate), corrosion inhibitors, and mixtures thereof. Other additives may be added to the binder composition for the improvement of process and product performance. Additives may be present in the binder composition from trace amounts (such as <about 0.1% by weight the binder composition) up to about 10% by weight of the total solids in the binder composition.

The reactive diluent polyol, polycarboxylic acid, and optional polyol may be combined to form a binder premix, prior to the addition of further binder components.

Exemplary binder premix compositions in accordance with the general inventive concepts are provided in Table 1, below. It is to be appreciated that any compositional range from Exemplary Composition A may be used in combination with any compositional range from Exemplary Composition B, and vice versa.

TABLE 1

| | Exemplary | Exemplary |
|---|---|---|
| | Composition A | Composition B |
| | (wt. % solids) | (wt. % solids) |
| Reactive diluent polyol(s) | 10-70 | 20-55 |
| Polycarboxylic acid | 20-75 | 30-60 |
| COOH:OH mole ratio | 0.3:1-1.8:1 | 0.8:1-1.25:1 |
| Optional (Secondary) Polyol | 0-30 | 2-15 |

The novel binder premix compositions disclosed herein demonstrate a complex modulus (G*) of below 0.0008 MPa at a binder premix solids percentage of at least 70% at ambient temperature (about 25° C.), including, for example, at a binder solids premix percentage of at least 75%, at least 80%, and at least 85%, The binder premix compositions may have a complex modulus of no greater than 0.0004 (MPa) at a solids content of at least 70%, including, for example, at least 75%, at least 80%, and at least 85%. Such embodiments include binder compositions with a complex modulus of no greater than 0.0003 MPa, no greater than 0.0002 MPa, and no greater than 0.0001 MPa at the above-mentioned binder premix solids percentage and ambient temperature.

It is generally known and accepted that binder viscosity increases as binder solids content increases. However, the novel binder composition surprisingly maintains a balanced and low viscosity, due to the binder's low complex modulus, even at a solids content at or exceeding 70%.

The binder compositions disclosed herein may be used to manufacture fibrous insulation products, such as fiberglass or mineral wool insulation products. Thus, aspects of the present inventive concepts are also directed to a method for producing an insulation product and includes the steps of contacting mineral wool and/or glass fibers with a binder composition as disclosed herein. The insulation product may comprise a facer on one or both of its major surfaces. The facer may be any type of facing substrate known in the art such as, for example, a nonwoven mat, a foil mat, a polymeric surfacing mat, a woven textile, and the like.

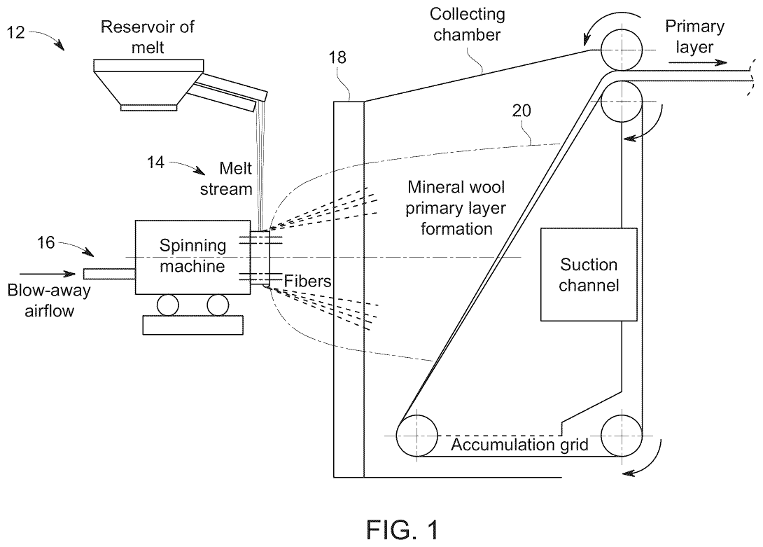

A typical method for producing a mineral wool product is outlined in FIG. 1. A melt of raw mineral materials is prepared in a reservoir 12 and a melt stream 14 is descended into a spinning machine 16 (such as a centrifugal spinner), where the melt is fiberized and blown into a collection chamber 18, forming a mineral wool web on a collection belt 20. The binder composition may be applied to the mineral wool fibers before collection on the collection belt, as the fibers are being collected, or after the formation of the mineral wool web. The binder composition may be applied to the mineral wool fibers by known means, such as, for example, by spraying. The binder-coated mineral wool web is then heated in a conventional curing oven to cure the binder-coated mineral wool web, forming a mineral wool product. The mineral wool web may be subjected to compression to obtain a desired final product thickness.

Curing may be carried out in a curing oven at conventional temperatures, such as, for example from about 200° C. to about 400° C., such as from about 225° C. to about 350° C., and from about 230° C. to about 300° C.

An exemplary method for forming a blanket comprising binder-coated fibers into rolls or logs of insulation before curing, for example pipe insulation, according to the present invention, is illustrated by FIG. 2. The formed blanket containing the binder-coated fibers can be further formed into a desired shape and cut into lengths, before it is cured, to better fit equipment and end-use needs. For instance, the blanket containing the binder-coated fibers can be formed into rolls or logs 32 before curing in a curing oven 34 to serve as pipe insulation. As part of this process, after the binder is applied to the blanket, rolls or logs of insulation are formed via a winding machine 36, the rolls or logs are sawed to the desired size, and then the rolls or logs are either cured in a curing oven 34, or stored and then later cured. This process can require the rolls or logs of insulation be stored for multiple days before they are cured and often experience a longer shelf life.

Formed or shaped products may include a further step, optionally during cure, that compresses, molds or shapes the product to its specific final shape. Rigid boards are a type of shaped product, the shape being planar. Other shaped products may be formed by dies or molds or other forming apparatus. Rigidity may be imparted by the use of higher density of fibers and/or by higher levels of binder application. As an alternative to rotary fiberizing, some fibrous insulation products, particularly higher density, non-woven insulation products, may be manufactured by an air-laid or wet-laid process using premade fibers of glass, mineral wool, or polymers that are scattered into a random orientation and contacted with binder to form the product.

The binder compositions produced in accordance with the present inventive concepts further demonstrate improved ability to maintain a low complex modulus under high binder solid percentages or conditions (for example, binder solid percentages of about 50% to 85%) and/or for an extended period (at least 1 to 5 days), making the product capable of being used for downstream product processes, such as a pipe forming processes, compared to a mineral wool insulation product formed with an otherwise identical binder composition that does not include the reactive diluent polyol.

Additionally, the insulation products produced in accordance with the present inventive concepts further demonstrate reduced wrinkling and bubbling during the winding process and reduced stickiness compared to an insulation product formed with an otherwise identical binder composition that does not include the reactive diluent polyol in the concentrations prescribed herein.

Having generally described this invention, a further understanding can be obtained by reference to certain specific examples illustrated below which are provided for purposes of illustration only and are not intended to be all inclusive or limiting unless otherwise specified.

### EXAMPLES

### Example 1

Exemplary binder premixes were prepared comprising glycerol as the reactive diluent polyol and low molecular weight polycarboxylic acid, as outlined in Table 2. Comparative Example 1 including an otherwise similar binder premix comprising sorbitol and only a minor portion (less than 10 wt. %) of a reactive diluent polyol. The respective binder compositions are listed below and based on the weight percent solids of the binder premix (i.e., excluding additional binder components):

TABLE 2

| | COMP EX 1 | EX 1 | EX 2 | EX 3 |
|---|---|---|---|---|
| | (wt. % | (wt. % | (wt. % | (wt. % |
| | solid) | solid) | solid) | solid) |
| Reactive diluent polyol | 10 | 50 | 30 | 40 |
| (glycerol) | | | | |
| Polycarboxylic acid (Mn = | 60 | 50 | 50 | 60 |
| 2,000 to 2,500 Daltons) | | | | |
| Polyol (sorbitol) | 40 | 0 | 30 | 0 |

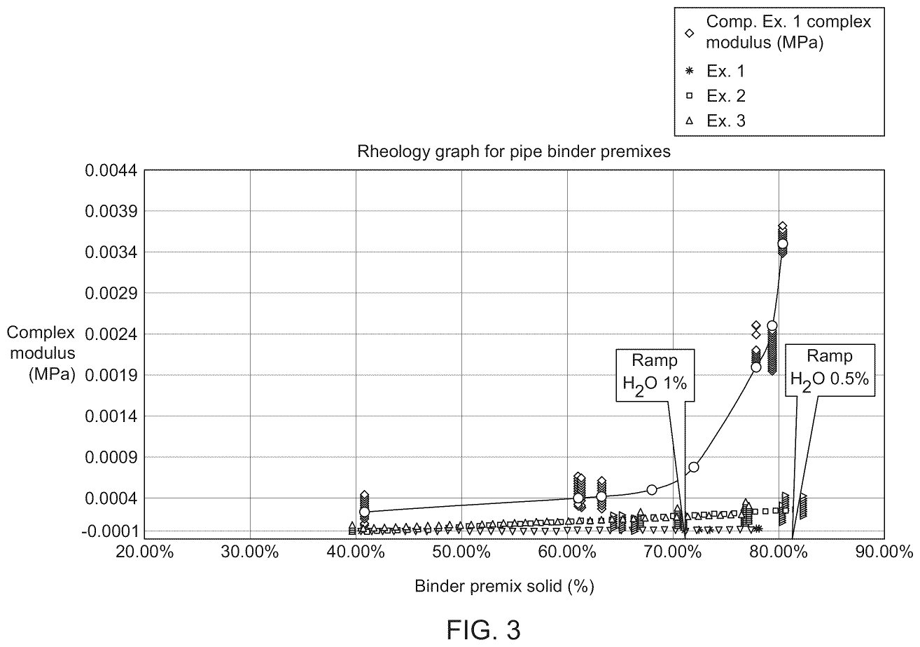

As illustrated in FIG. 3, Examples 1-3 each demonstrate a substantially reduced complex modulus over a binder solids content range of 40% to 80%, compared to Comparative Example 1. Particularly, Comparative Example 1, having 40 wt. % of a non-reactive diluent polyol (sorbitol) and only 10 wt. % of a reactive diluent polyol demonstrated a complex modulus greater than 0.0004 MPa as the binder composition exceeded 60% solids content and then experienced an exponential increase in complex modulus as the binder solids content exceeded 70%. In contrast, each of Examples 1-3 remained below a storage modulus of 0.0004 MPa, even as the binder solids content exceeded 80%.

### Example 2

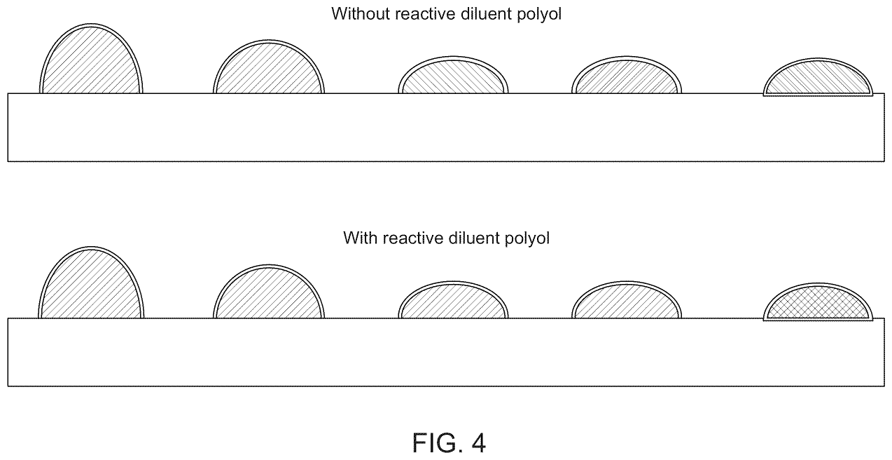

Uncured binder droplets of similar binder samples were prepared that either did not include a reactive diluent polyol (FIG. 4, top sample, Comparative Ex 1, detailed above) or that included the reactive diluent polyol (FIG. 4, bottom sample). The samples were then subjected to a binder skin healing test to illustrate how the binder reacts to a material being impinged in it, then retracted quickly. This test utilizes Instron's TestProfiler software which facilitates complex test methods. For each test, two grams of each binder sample was placed in an aluminum dish and allowed to dry in ambient conditions for a period of 3 days. A pin connected to the Instron's 5N load cell was then lowered into each dried binder at a very slow speed, 0.125 in/min. The load was measured continuously. Any resistance exerted was captured by the Instron. The resistance captured reflects the status of the binder droplet: low viscosity liquid gives low resistance and gel/semi solid gives high resistance.

As shown below Table 3 and in FIG. 4, when a reactive diluent was included in the binder composition, the binder droplet remained liquid for a longer period of time and even after 3 days, maintained more moisture than an otherwise identical binder composition without the reactive polyol, which did not maintain its liquid state for nearly as long (less than 1 day).

TABLE 3

| Time | Ramp | Day 0 | Day 1 | Day 2 | Day 3 |
|---|---|---|---|---|---|
| Moisture | 2.5 | 1.48 | 0.89 | 1.11 | 0.88 |
| Binder Solid (%) | 52 | 61 | 72 | 67 | 72 |
| Without reactive | Liquid | Liquid | Dry | Dry | Dry |
| diluent polyol | | | surface | Surface | Surface |
| With reactive | Liquid | Liquid | Liquid | Liquid | Slightly |
| diluent polyol | | | | | Dry |

### Example 3

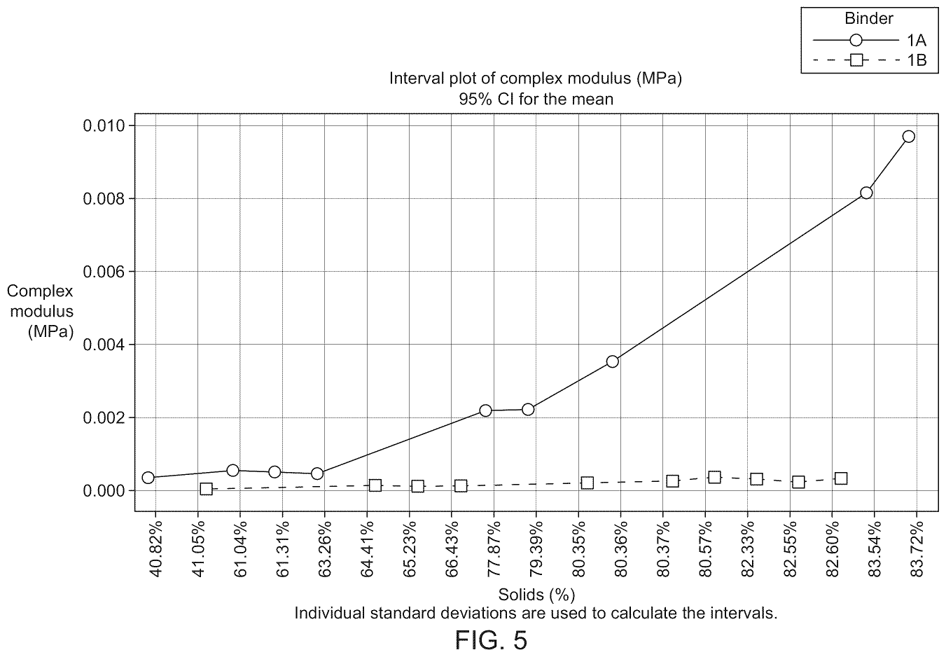

Comparative Example 1 (Binder 1A) and Example 1 (Binder 1B) from Table 2, above, were again prepared and tested for complex modulus over a binder solids content of about 40% to about 83.7% at ambient temperature (˜25° C.). As the graph of FIG. 5 illustrates, the binder premix of Binder 1B demonstrates a substantially lower complex modulus over the entire binder solids range compared to Binder 1A, and is particularly well below 0.001 MPa at a solids content of over 80%. In contrast, the binder of Binder 1A reaches a 0.002 MPa complex modulus at 77.8% solids, exceeds 0.004 MPa complex modulus at about 80.365% solids, and is close to 0.010 MPa complex modulus at a solids content of 83.72%. Such a large difference in complex modulus clearly demonstrates the surprising impact that the incorporation of at least 20 wt. % of a reactive diluent polyol has on a binder composition, such that an increase in solids content doesn't cause an increase in modulus.

### Example 4

The exemplary binder composition of Example 1 was again prepared, along with a second exemplary binder composition (Example 2), as outlined below in Table 4. Comparative Example 1 including an otherwise similar binder composition that includes a higher molecular weight polyacrylic acid (Mn=2,000 to 2,500 Daltons), sorbitol, and includes only a minor portion (less than 10 wt. %) of a reactive diluent polyol. The respective binder compositions are listed below in Table 4.

TABLE 4

| | COMP. | COMP. | | |
|---|---|---|---|---|
| | EX. 1 | EX. 2 | EX. 1 | EX. 2 |
| | (wt. % | (wt. % | (wt. % | (wt. % |
| | solids) | solids) | solids) | solids) |
| Reactive diluent polyol | 5.55 | — | 42.95 | 42.95 |
| (glycerol) | | | | |
| Low molecular weight | — | — | — | 42.95 |
| polyacrylic acid (1,000 | | | | |
| Daltons) | | | | |
| Polyacrylic acid (Mn = | 33.31 | 59 | 42.95 | — |
| 2,000 to 2,500 | | | | |
| Daltons) | | | | |
| Polyol (sorbitol) | 22.21 | 25.29 | — | — |
| Sodium Hypophosphite | 0.78 | 1.18 | — | — |
| Ammonium Hydroxide | — | 5.58 | — | — |
| Surfynol 465 | 0.25 | 0.25 | 0.25 | 0.25 |
| Mineral Oil Emulsion | 25.00 | 5.7 | 8.70 | 8.70 |
| Silicone | 11.90 | 2 | 4.14 | 4.14 |
| Silane | 1.00 | 1.00 | 1.00 | 1.00 |

Each binder composition was analyzed for viscosity at various solids concentration. The measurements were obtained by a process whereby the compositions were prepared at the highest possible solids concentration for each sample. The material was then split into two portions. The first portion, referred to as the ‘Initial Portion’, was set aside for viscosity measurement. The second portion, referred to as the ‘Enriched Portion’, was heated to 40-41° C. (+10° C.) under constant mixing in a well-ventilated area to promoted water evaporation. Water was evaporated out of the material until the solids content reached either 80% or the highest concentration possible without entrapping air in the material. The ‘Enriched Portion’ was cooled to room temperature (about 25° C.) before viscosity measurements were taken. The solids concentration measurements were performed using a CEM Smart 6, a microware+infrared moisture and solids analyzer. The viscosity measurements were performed using a Brookfield DV-II+ Pro viscometer, a low-shear spindle-style viscometer, using standard Brookfield LV spindle numbers 61, 62, 63, and 64. On this viscometer, the available RPM settings are 200, 105, 60, 20, 6, 3, 2.5, and 0.6. The target maximum and minimum solids concentrations were 80% and 10%, respectively. The initial solids concentration varied for each sample.

The solids concentration of the ‘Initial Portion’ was measured and recorded, and an initial viscosity measurement was taken. Based on this initial measurement, and previous viscosity vs. solids concentration data, two target measurement RPMs were selected. The target RPMs could be 200, 105, 60, or 20. The material's viscosity was measured at each target RPM with each spindle, recording the spindle used, RPM setting, viscosity reading, and torque reading at each measurement. The data sets for each target RPM were recorded separately for each sample.

Next, the sample's solids content was reduced by 5% (±2%) by adding deionized water and thoroughly mixing the sample. The sample's new solids content was measured and recorded. The sample's viscosity was measured at each target RPM with each spindle, recording the RPM, viscosity, and torque at each measurement. When using the smallest spindle (spindle 61), if the measured torque was below 10%, then the RPM was increased by one setting and the measurement was recorded again. This process (dilution, solids content measurement, and viscosity measurement) was repeated until the sample's viscosity had been measured at the minimum target solids concentration of 10% (±1%).

The solids concentration of the ‘Enriched Portion’ was then measured and recorded. The sample's viscosity was measured at each target RPM at room temperature with each spindle, recording the RPM, viscosity, and torque at each measurement. When using the largest spindle (spindle 64), if the measured torque was above 90%, then the RPM was decreased by one setting and the measurement was recorded again.

Next, the sample's solids content was reduced by 5% (±2%) by adding deionized water and thoroughly mixing the sample. The sample's new solids content was measured and recorded. The sample's viscosity was measured at each target RPM at room temperature with each spindle, recording the spindle used, RPM setting, viscosity reading, and torque reading at each measurement. This process (dilution, solids content measurement, and viscosity measurement) was repeated until the sample's viscosity had been measured at a solids content equal to the initial solids content of the ‘Initial Portion’ plus 5%.

After all of the viscosity measurements for a sample were collected, one spindle/RPM/viscosity/torque measurement was selected to be reported for each solids' concentration level. To select the proper results, the data set with the largest number of values recorded at the target RPM with torque measurements between 10%-90% was identified. Within that data set, for each solids' concentration level, the measurement generated by the smallest spindle with a torque greater than 10% was reported.

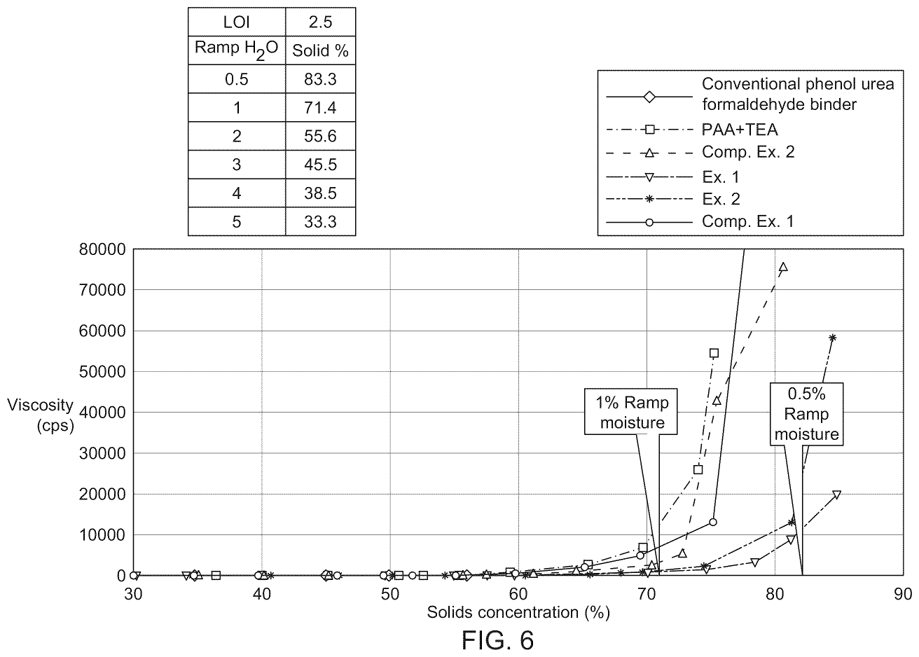

FIG. 6 illustrates the viscosity curve at ambient temperature (about 25° C.) for Examples 1 and 2, along with and Comparative Examples 1 and 2, each at 2.5% LOI, over a binder solids content of about 30% to about 85%. FIG. 6 further includes conventional phenol urea formaldehyde (PUF) binder and polyacrylic acid and triethanolamine-based binders, as benchmarks. As FIG. 6 illustrates, Examples 1 and 2 maintain a viscosity well below 10,000 cps, even at a solids content above 75%. The graph of FIG. 6 further illustrates that at a 1% ramp moisture (71.4% solids), Examples 1 and 2 demonstrate viscosities less than 2,000 cps compared to Comparative Examples 1 and 2, having viscosities over 5,000 cps. At a ramp moisture of 0.5% (83.3% solids), Examples 1 and 2 demonstrated viscosity values below 20,000 cps, while Comparative Examples 1 and 2 were unable to be measured due to the viscosity being so high.

It will be appreciated that many more detailed aspects of the illustrated products and processes are in large measure, known in the art, and these aspects have been omitted for purposes of concisely presenting the general inventive concepts. Although the present invention has been described with reference to particular means, materials and embodiments, from the foregoing description, one skilled in the art can easily ascertain the essential characteristics of the present disclosure and various changes and modifications can be made to adapt the various uses and characteristics without departing from the spirit and scope of the present invention as described above and set forth in the attached claims.

The following paragraphs provide further exemplary embodiments.

Paragraph 1. A fibrous insulation product with an extended uncured shelf life comprising:
a plurality of randomly oriented fibers; and
a binder composition at least partially coating the fibers, characterized in that the binder composition has a complex modulus of no greater than 0.0004 MPa at a binder solids content of between 65% and 85%, the binder composition being free of added formaldehyde and is applied to the fibers as an aqueous binder composition comprising:
   at least 20% by weight of a reactive diluent polyol, wherein the reactive diluent polyol is substantially in liquid form at a solids content above 70% at ambient temperature;
   at least 30% by weight of a polymeric crosslinking agent comprising at least two carboxylic acid groups;
   optionally, a protective agent; wherein the binder composition is included in the fibrous insulation product at an LOI (loss on ignition) of 0.5 to 4%.

Paragraph 2. The fibrous insulation product of claim 1, wherein the reactive diluent polyol has a solubility of greater than 95% at a solids content of 100%.

Paragraph 3. The fibrous insulation product of claim 1 or claim 2, wherein the reactive diluent polyol comprises glycerol, polyglycerol, propylene glycol, ethylene glycol, diethylene glycol, polyethylene glycol, triethanolamine, 1,3-butanediol, or mixtures thereof.

Paragraph 4. The fibrous insulation product of any preceding claim, wherein the reactive diluent polyol comprises glycerol, polyglycerol, or mixtures thereof.

Paragraph 5. The fibrous insulation product of any preceding claim, wherein the reactive diluent polyol is included in the binder composition in an amount from 25 wt. % to 65 wt. %.

Paragraph 6. The fibrous insulation product of any preceding claim, wherein the binder composition includes 1.25 wt. % to 20 wt. % of an ammonium-based protective agent.

Paragraph 7. The fibrous insulation product of any preceding claim, wherein the binder composition further includes a secondary polyol comprising one or more of a sugar alcohol, pentaerythritol, and alkanolamine.

Paragraph 8. The fibrous insulation product of claim 7, wherein the secondary polyol is included in the binder composition in an amount less than 30 wt. %.

Paragraph 9. The fibrous insulation product of any preceding claim, wherein the aqueous binder composition has a complex modulus below 0.0008 MPa at a binder premix solids percentage of at least 70%.

Paragraph 10. The fibrous insulation product of any preceding claim, wherein the aqueous binder composition has a complex modulus below 0.0004 MPa at a binder premix solids percentage of at least 70%,

Paragraph 11. The fibrous insulation product of any preceding claim, wherein the fibrous insulation product comprises a mineral wool insulation product.

Paragraph 12. The fibrous insulation product of any preceding claim, wherein the fibrous insulation product comprises pipe insulation.

Paragraph 13. An aqueous binder composition for forming a fibrous insulation product with an extended uncured shelf life, characterized in that the binder composition, at a solids content of at least 70%, demonstrates an impinge resistance after exposure to ambient conditions for 120 hours of less than 0.3 mm and a complex modulus of less than 0.0008 MPa, the binder composition being free of added formaldehyde and comprising:
at least 20% by weight of a reactive diluent polyol, wherein the reactive diluent polyol is substantially in liquid form at a solids content above 70% at ambient temperature; and
at least 30% by weight of a polymeric crosslinking agent comprising at least two carboxylic acid groups.

Paragraph 14. The aqueous binder composition of claim 13, wherein the reactive diluent polyol is substantially in liquid form at a solids content of above 95% at ambient temperature.

Paragraph 15. The aqueous binder composition of claim 13 or claim 14, wherein the reactive diluent polyol comprises glycerol, polyglycerol, propylene glycol, ethylene glycol, diethylene glycol, polyethylene glycol, triethanolamine, 1,3-butanediol, or mixtures thereof.

Paragraph 16. The aqueous binder composition of any of claims 13 to 15, wherein the reactive diluent polyol comprises glycerol, polyglycerol, or mixtures thereof.

Paragraph 17. The aqueous binder composition of any of claims 13 to 16, wherein the reactive diluent polyol is included in the binder composition in an amount from 25 wt. % to 65 wt. %.

Paragraph 18. The aqueous binder composition of any of claims 13 to 17, wherein the polymeric crosslinking agent has a number-average molecular weight of less than or equal to 1,000.

Paragraph 19. The aqueous binder composition of any of claims 13 to 18, wherein the binder composition includes 1.25 wt. % to 20 wt. % of an ammonium-based protective agent.

Paragraph 20. The aqueous binder composition of any of claims 13 to 19, wherein the binder composition further includes a secondary polyol comprising one or more of a sugar alcohol, pentaerythritol, and alkanolamine.

Paragraph 21. The aqueous binder composition of claim 20, wherein the secondary polyol is included in the binder composition in an amount less than 30 wt. %.

Paragraph 22. The aqueous binder composition of any of claims 13 to 21, wherein the aqueous binder composition has a complex modulus below 0.0004 MPa at a binder premix solids percentage of at least 70%.

Paragraph 23. A method for extending the uncured shelf life of an insulation product formed with a binder composition that is free of added formaldehyde comprising:
forming an uncured insulation blanket from a plurality of randomly oriented fibers at least partially coated with an aqueous binder composition, the aqueous binder composition comprising:
   at least 20% by weight of a reactive diluent polyol, wherein the reactive diluent polyol is substantially in liquid form at a solids content above 70% at ambient temperature; and
   at least 30% by weight of a polymeric crosslinking agent comprising at least two carboxylic acid groups, wherein the aqueous binder composition has a complex modulus of no greater than 0.0008 MPa at a solids content of at least 70%; and
curing the insulation blanket to form a fibrous insulation product.

Paragraph 24. The method of claim 23, wherein the insulation product is uncured pipe insulation.

Paragraph 25. The method of claim 23 or claim 24, wherein the step of curing the insulation product occurs after at least 2 days.

Paragraph 26. The method of any one of claims 23 to 25, wherein the uncured insulation blanket maintains a complex modulus of no greater than 0.0008 MPa at a solids content of at least 70% after at least 2 days.

Paragraph 27. The method of any one of claims 23 to 26, wherein the uncured insulation blanket maintains a complex modulus of no greater than 0.0008 MPa at a solids content of at least 70% after at least 5 days.

Paragraph 28. The method of any of claims 23 to 27, wherein the reactive diluent polyol has a solubility of greater than 95% at a solids content of 100%.

Paragraph 29. The method of any of claims 23 to 28, wherein the reactive diluent polyol is substantially in liquid form at a solids content of above 95% at ambient temperature.

Paragraph 30. The method of any of claims 23 to 29, wherein the reactive diluent polyol comprises glycerol, polyglycerol, propylene glycol, ethylene glycol, diethylene glycol, polyethylene glycol, triethanolamine, 1,3-butanediol, or mixtures thereof.

Paragraph 31. The method of any of claims 23 to 30, wherein the reactive diluent polyol comprises glycerol, polyglycerol, or mixtures thereof.

Paragraph 32. The method of any of claims 23 to 31, wherein the reactive diluent polyol is included in the binder composition in an amount from 25 wt. % to 65 wt. %.

What is claimed is:

1. A fibrous insulation product with an extended uncured shelf life comprising:
a plurality of randomly oriented fibers; and
a binder composition at least partially coating the fibers, characterized in that the binder composition has a complex modulus of no greater than 0.0004 MPa at a binder solids content of between 65% and 85%, the binder composition being free of added formaldehyde and is applied to the fibers as an aqueous binder composition comprising:
at least 20% by weight of a reactive diluent polyol, wherein the reactive diluent polyol is substantially in liquid form at a solids content above 70% at ambient temperature;
at least 30% by weight of a polymeric crosslinking agent comprising at least two carboxylic acid groups; and
optionally, a protective agent;
wherein the binder composition is included in the fibrous insulation product at an LOI (loss on ignition) of 0.5 to 4%.

2. The fibrous insulation product of claim 1, wherein the reactive diluent polyol has a solubility of greater than 95% at a solids content of 100%.

3. The fibrous insulation product of claim 1, wherein the reactive diluent polyol comprises glycerol, polyglycerol, propylene glycol, ethylene glycol, diethylene glycol, polyethylene glycol, triethanolamine, 1,3-butanediol, or mixtures thereof.

4. The fibrous insulation product of claim 1, wherein the reactive diluent polyol comprises glycerol, polyglycerol, or mixtures thereof.

5. The fibrous insulation product of claim 1, wherein the reactive diluent polyol is included in the binder composition in an amount from 25 wt. % to 65 wt. %.

6. The fibrous insulation product of claim 1, wherein the binder composition includes 1.25 wt. % to 20 wt. % of an ammonium-based protective agent.

7. The fibrous insulation product of claim 1, wherein the binder composition further includes a secondary polyol comprising one or more of a sugar alcohol, pentaerythritol, and alkanolamine.

8. The fibrous insulation product of claim 7, wherein the secondary polyol is included in the binder composition in an amount less than 30 wt. %.

9. The fibrous insulation product of claim 1, wherein the aqueous binder composition has a complex modulus below 0.0008 MPa at a binder solids percentage of at least 70%.

10. The fibrous insulation product of claim 1, wherein the aqueous binder composition has a complex modulus below 0.0004 MPa at a binder solids percentage of at least 70%.

11. The fibrous insulation product of claim 1, wherein the fibrous insulation product comprises a mineral wool insulation product.

12. The fibrous insulation product of claim 1, wherein the fibrous insulation product comprises pipe insulation.

13. An aqueous binder composition for forming a fibrous insulation product with an extended uncured shelf life, characterized in that the binder composition, at a solids content of at least 70%, demonstrates an impinge resistance after exposure to ambient conditions for 120 hours of less than 0.3 mm and a complex modulus of less than 0.0008 MPa, the binder composition being free of added formaldehyde and comprising:
at least 20% by weight of a reactive diluent polyol, wherein the reactive diluent polyol is substantially in liquid form at a solids content above 70% at ambient temperature; and
at least 30% by weight of a polymeric crosslinking agent comprising at least two carboxylic acid groups.

14. The aqueous binder composition of claim 13, wherein the reactive diluent polyol is substantially in liquid form at a solids content of above 95% at ambient temperature.

15. The aqueous binder composition of claim 13, wherein the reactive diluent polyol comprises glycerol, polyglycerol, propylene glycol, ethylene glycol, diethylene glycol, polyethylene glycol, triethanolamine, 1,3-butanediol, or mixtures thereof.

16. The aqueous binder composition of claim 13, wherein the binder composition includes 1.25 wt. % to 20 wt. % of an ammonium-based protective agent.

17. The aqueous binder composition of claim 13, wherein the binder composition further includes a secondary polyol comprising one or more of a sugar alcohol, pentaerythritol, and alkanolamine.

18. The aqueous binder composition of claim 17, wherein the secondary polyol is included in the binder composition in an amount less than 30 wt. %.

19. The aqueous binder composition of claim 13, wherein the aqueous binder composition has a complex modulus at below 0.0004 MPa at a binder solids percentage of at least 70%.

20. A method for extending the uncured shelf life of an insulation product formed with a binder composition that is free of added formaldehyde comprising:
forming an uncured insulation blanket from a plurality of randomly oriented fibers at least partially coated with an aqueous binder composition, the aqueous binder composition comprising:
at least 20% by weight of a reactive diluent polyol, wherein the reactive diluent polyol is substantially in liquid form at a solids content above 70% at ambient temperature; and
at least 30% by weight of a polymeric crosslinking agent comprising at least two carboxylic acid groups, wherein the aqueous binder composition has a complex modulus of no greater than 0.0008 MPa at a solids content of at least 70%; and
curing the insulation blanket to form a fibrous insulation product.

21. The method of claim 20, wherein the insulation product is uncured pipe insulation.

22. The method of claim 20, wherein the step of curing the insulation product occurs after at least 2 days.
